(19) United States
(12) Patent Application Publication
(10) Pub. No.: US 2025/0070999 A1
(43) Pub. Date: Feb. 27, 2025

(54) METHOD FOR VIRTUAL NETWORK TRANSMISSION, APPARATUS, AND STORAGE MEDIUM

(71) Applicant: ZTE CORPORATION, Shenzhen (CN)

(72) Inventors: Zhendong LI, Shenzhen (CN); Jinguo ZHU, Shenzhen (CN)

(21) Appl. No.: 18/724,907

(22) PCT Filed: Jan. 21, 2022
(86) PCT No.: PCT/CN2022/073075

§ 371 Date: Jun. 27, 2024

(51) Int. Cl. H04L 12/46

(52) U.S. Cl. CPC H04L 12/4641; H04L 12/4633

(57) ABSTRACT

A wireless communication method performed by a first SMF of a wireless core network includes receiving a first virtual network (VN) session request from a second SMF, the first VN session request including at least one of a virtual network (VN) identifier (ID) of a VN, first routing information, or first data communication tunnel information for a first VN data communication session; sending a first VN session response; and configuring, according to the first routing information, a first packet detection rule (PDR) and a first forwarding action rule (FAR) for a first User Plane Function (UPF) associated with the first SMF to forward data packets of the first VN data communication session. Other methods, a wireless communication apparatus, and non-transitory computer readable storage medium performing the wireless communication methods are disclosed.

### TECHNICAL FIELD

This disclosure relates to virtual network implemented in wireless network, and particularly to operation of wireless virtual network across geographic service regions.

### BACKGROUND

Virtual network (VN) group communication may be implemented and supported by a wireless communication platform. A VN group communication in wireless communication platform functions, in some aspects, as a counterpart of, for example Virtual Private Network (VPN) in data network, and provides secure wireless communication between mobile devices associated with a virtual group established by any organization, company, institution, and the like. A VN group communication in the 5G wireless communication network platform may be implemented according to the system shown in FIG. 1. In such a system/platform, and within its core network, a main Session Management Function (SMF) controls two or more User Plane Function (UPF), including UPF-1 and UPF-2. Each UPF may serve as a PSA (PDU session Anchor), to which one or more user equipments (UEs) establish PDU sessions. The PDU sessions are used by the network to provide UEs with end-to-end user plane connectivity between with other UEs or specific Data Networks (DNS) via the UPFs. Further, NG Radio Access Network (NG-RAN) can act between the UPF and the UE to provide, for example, new radio (NR) and/or LTE radio access of the core network to the UE. In a traditional VN implementation, all PDUs involved in a VN group communication session may be controlled by a same SMF. The service area of a single SMF is limited geographically, thereby limiting the scope and geographic range of the VN group communication.

### SUMMARY

An embodiment of this disclosure provides a communication method performed by a first Session Management Function (SMF) in a wireless core network. The method includes in response to a User Equipment (UE) requesting a communication session, registering or updating with a Virtual Network (VN) management network node at least one of information item associated with the first SMF or a VN identifier (ID) of the VN; obtaining information of a second SMF associated with the VN from the VN management network node; and establishing a VN session with the second SMF according to the information of the second SMF.

Another embodiment of this disclosure provides another wireless communication method performed by a first Session Management Function (SMF) in a wireless core network. The method includes establishing a Virtual Network (VN) session with a second SMF; establishing a data communication tunnel between a first User Plain Function (UPF) and a second UPF, the first UPF being assigned by a first SMF to assist a User Equipment (UE) with a communication session associated with a VN and the second UPF being assigned by a second SMF associated with the VN; in response to receiving a communication session release request from the UE, determining whether all data communication sessions anchored in the first UPF for the VN have been released; and in response to determining that all the data communication sessions anchored in the first UPF for the VN has been released, commanding the first UPF to release the data communication tunnel.

Another embodiment of this disclosure provides another wireless communication method performed by a first SMF of a wireless core network. The method includes receiving a first virtual network (VN) session request from a second SMF, the first VN session request including at least one of a virtual network (VN) identifier (ID) of a VN, first routing information, or first data communication tunnel information for a first VN data communication session; sending a first VN session response including at least one of the VN ID, second routing information of the first SMF, or second data communication tunnel information for the first VN data communication session; and configuring, according to the first routing information, a first packet detection rule (PDR) and a first forwarding action rule (FAR) for a first User Plane Function (UPF) associated with the first SMF to forward data packets of the first VN data communication session.

Another embodiment of this disclosure provides another wireless communication method. The method includes receiving, by an intermediate Session Management Function (iSMF) and from a first Session Management Function (SMF), at least one of a virtual network (VN) identifier (ID), a routing information of the first SMF, or data communication tunnel information of a first User Plane Function (UPF); and transmitting, by the iSMF, to a second SMF, at least one of the VN ID, data communication tunnel information of an iUPF, and the routing information of the first SMF.

Another embodiment of this disclosure provides a wireless communication apparatus, including one or more processors and a memory. The memory stores one or more instructions. When the one or more instructions are executed by the one or more processors, one or more processors causes the wireless communication apparatus to perform any one of the steps disclosed in this disclosure.

Another embodiment of this disclosure provides non-transitory computer readable storage medium. The non-transitory computer readable storage medium stores one or more instructions. When the one or more instructions are executed by one or more processors, it causes a wireless communication apparatus to perform any one of the steps disclosed in this disclosure.

### BRIEF DESCRIPTION OF THE DRAWINGS

FIG. 1 shows a system structure for implementing a virtual network in a wireless communication network platform;

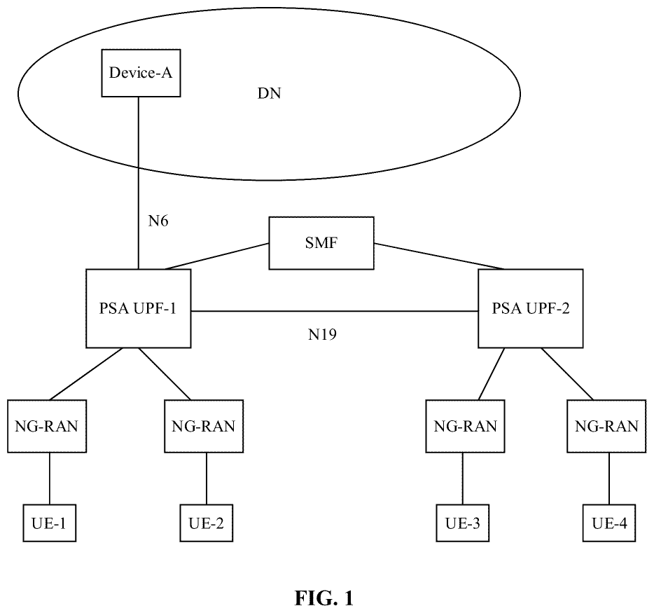

FIG. 2A shows an example virtual network (VN) topology in a wireless communication network platform according to an embodiment of this disclosure;

FIG. 2B shows another example virtual network (VN) topology in a wireless communication network platform according to another embodiment of this disclosure;

FIG. 3A shows example signal flow among various core network components for a wireless virtual network according to an embodiment of this disclosure;

FIG. 3B shows another example signal flow among various core network components for a wireless virtual network according to an embodiment of this disclosure

FIG. 4A shows another example signal flow among various core network components for a wireless virtual network according to an embodiment of this disclosure;

FIG. 4B shows another example signal flow among various core network components for a wireless virtual network according to an embodiment of this disclosure;

FIG. 5A shows another example signal flow among various core network components for a wireless virtual network according to an embodiment of this disclosure;

FIG. 5B shows another example signal flow among various core network components for a wireless virtual network according to an embodiment of this disclosure;

FIG. 6 shows another example signal flow among various core network components for a wireless virtual network according to an embodiment of this disclosure;

FIG. 7 shows another example signal flow among various core network components for a wireless virtual network according to an embodiment of this disclosure;

FIG. 8 shows another example signal flow among various core network components for a wireless virtual network according to an embodiment of this disclosure;

FIG. 9 shows yet another example signal flow among various core network components for a wireless virtual network according to an embodiment of this disclosure; and

FIG. 10. shows example system hardware structure according to one embodiment of this disclosure.

### DETAILED DESCRIPTION

The exemplary embodiments are described comprehensively with reference to the accompanying drawings. However, the exemplary embodiments may be implemented in various forms and are not to be understood as limited to the embodiments described herein; on the contrary, providing these embodiments will make this disclosure more comprehensive and complete, and comprehensively convey the concept of the exemplary embodiments to a person skilled in the art. A same reference numeral in the accompanying drawings represents same or similar components, and therefore repeated descriptions of the components are appropriately omitted.

The features, structures, or characteristics described in this disclosure may be combined in one or more implementations in any appropriate manner. In the following description, many specific details are provided to give a full understanding of the implementations of this disclosure. However, it is to be appreciated by a person skilled in the art that one or more of the specific details may be omitted during practice of the technical solutions of this disclosure, or other methods, components, apparatuses, steps, or the like may be used. In other cases, well-known methods, apparatuses, implementations, or operations are not shown or described in detail, in order not to obscure the aspects of this disclosure.

The accompanying drawings are merely schematic illustrations of this disclosure. The same reference numbers in the accompanying drawings represent the same or similar parts, and therefore, repeated descriptions thereof are omitted. Some of the block diagrams shown in the accompanying drawings do not necessarily correspond to physically or logically independent entities. The functional entities may be implemented in the form of software, or implemented in one or more hardware modules or integrated circuits, or implemented in different networks and/or processor apparatuses and/or micro-controller apparatuses.

The flowcharts shown in the accompanying drawings are merely examples for descriptions, do not necessarily include all content and steps, and are not necessarily performed in the described orders. For example, some steps may further be decomposed, and some steps may be merged or partially merged. As a result, an actual execution order may be changed according to an actual situation.

In this specification, words such as “one”, “a/an”, “the”, and “at least one” are used to indicate the presence of one or more elements/components or the like; words such as “contain”, “comprise”, and “include” are used in an opened inclusive sense and mean that additional elements/components or the like may further exist apart from the elements/components or the like listed; and words such as “first”, “second”, “third”, or the like are used merely as markers, and do not constitute quantitative restrictions on the objects thereof.

The following describes the exemplary implementations of this disclosure in detail with reference to the accompanying drawings.

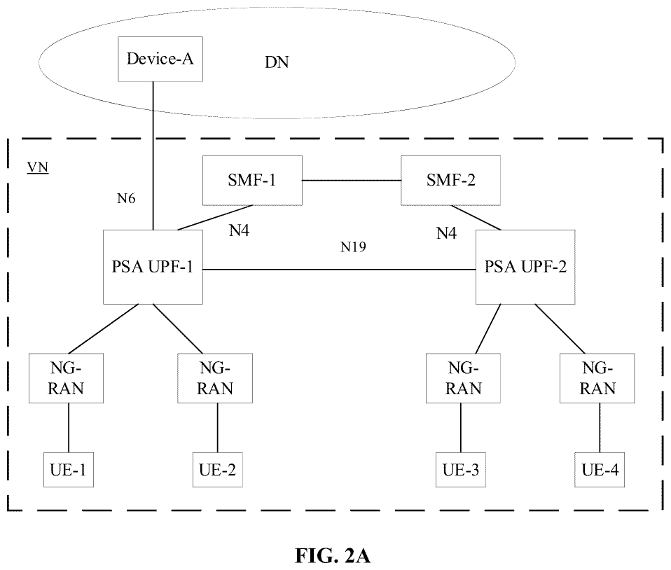

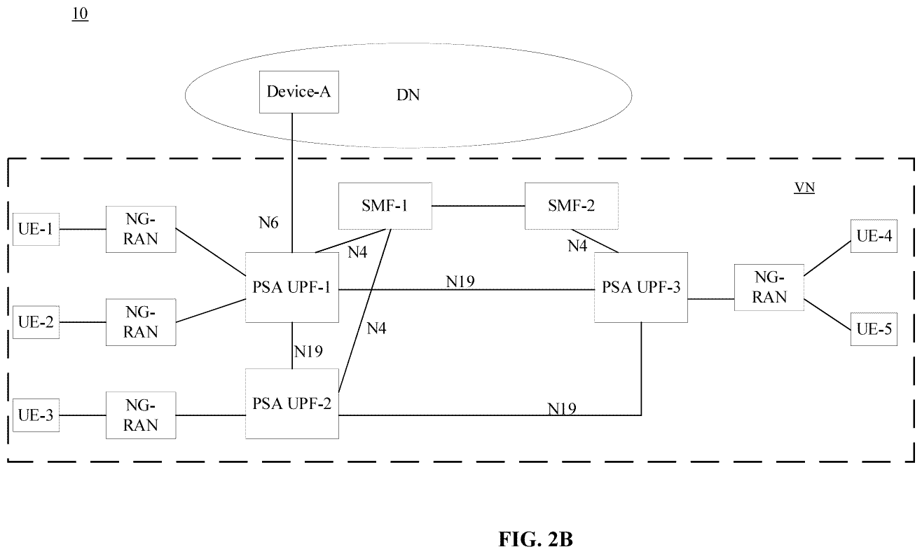

FIG. 2A shows a virtual network (VN) topology in a wireless communication network system 10 according to an embodiment of this disclosure. In this wireless communication system 10, the VN may be supported by SMF-1 and SMF-2. The SMF-1 assigns UPF-1 as an PSA to manage one or more UEs such as UE-1 and UE-2 via one or more NG-RANs. The UE-1 and UE-2 may each establish an PDU session with the UPF-1. Likewise, SMF-2 assigns UPF-2 as another PSA to manage one or more UEs such as UE-3 and UE-4 via one or more NG-RANs. The UE-3 and UE-4 may each establish an PDU session with the UPF-2. The UPF-1 and UPF-2 may establish a data communication tunnel, such as an N19 tunnel, and additionally the SMF-1 and the SMF-2 may communicate with each other in manners described in further detail below. Connections via, for example, N4 interfaces, may be established between the SMF-1 and the UPF-1 or between UPF-2 and SMF-2. The SMFs then can configures sets of packet detection rule (PDR) and/or a set of forwarding action rule (FAR) for the UPF-1 and UPF-2. Such rules can be used to enable a proper routing of the data traffic among the different VN group members in the VN.

In a VN communication, a UE may send data to another specific member UE within the VN as a unicast communication message/session. The UE may alternatively send data to all other member UEs who are online using a broadcast communication message/session. The UE may also send data to a subset of all the UEs of the VN using a multicast communication message/session. The UPF associated with the UE may be configured to route the UE data communication accordingly. When a UE requests to establish a PDU session, it may specify that the PDU session is for VN communication. The VN targeted by the requested PDU session may be identified by a particular Data Network Name (DNN) or Single Network Slice Selection Assistance information (S-NSSAI) of the VN.

Specifically, the VN data transmission of a UE in the wireless communication system 10 may include local UPF data switching inter-UPF data forwarding (e.g., via N19 interface depicted in FIG. 2A), and UPF-to-DN data forwarding (e.g., via N6 interface depicted in FIG. 2A). In a local UPF data switching, the UPF, such as the UPF-1 receives and the forwards a data packet from the UE-1 to the UE-2 via the PDU session between the UE-1 and UPF-1 and the PDU session between the UE-2 and the UPF-1. Such local UPF data switching is application for VN communication between local UEs managed by a same UPF. In the inter-UPF data forwarding scheme, for example, the UPF-1 may forward a data packet it receives to the UPF-2 via the date communication tunnel N19 therebetween. UPF-2 may be associated with a separate SMF from that of the UPF-1, as shown in FIG. 2A. Alternatively, UPF-2 and UPF-1 may be associated with a same SMF (not shown in FIG. 2A). The data packet received by the UPF-2 may later be dispatched to the UE-3 or UE-4 according to the designated recipient(s). The inter-UPF data forwarding scheme is thus application for VN data communication between UEs across UPFs. In a UPF-to-DN data forwarding scheme, a UPF can forward a received data packet to the data network DN via, for example the data communication tunnel N6.

FIG. 2B shows another virtual network (VN) topology in a wireless communication network system 10 according to another embodiment of this disclosure, where multiple UPFs may be associated with one SMF. Specifically, in the example of FIG. 2B, the UPF-1 and UPF-2 are configured by or associated with the same SMF-1. The UPF-3 is configured by or associated with another SMF-2. Again, example N4 connections may be established respectively between the SMF-1 and the UPF-1 or UPF-2 and also between the SMF-2 and UPF-3. Additionally, example N19 connections may be established between the UPF-1 and UPF-2, between the UPF-2 and UPF-3, and between the UPF-2 and UPF-3.

### SMFs Discovering in a Virtual Network

The VN topology, as depicted in FIG. 2A, includes SMF1 and SMF2. SMF1 and SMF2 may be remote to one another (e.g., may be associated with different geographic regions). Various implementations below describes the example manner in which SMF-1 or SMF-2 can discover one another and/or discover other network nodes associated with the VN group. In one implementation, when a UE requests to establish a PDU session associated with the VN group with one UPF configured by or associated with the SMF-1, the SMF-1 serving as an anchoring SMF can provide information of the SMF-1 and a VN identification (ID) of the VN, the UE requests to participate into the VN group communication, to a VN management network node, so as to register the SMF-1 as active with respect to the VN group communication. Later, when another UE requests to establish another PDU sessions with another UPF under another SMF, such as the SMF-2, the SMF-2 can retrieve the information of SMF-1 (and other SMF registered with the VN network management node for active VN group communications) based on the VN ID of the VN, which the UE will enroll to. Then, the SMF-2 can establish communication with the SMF-1 to establish an inter SMF VN session.

Exemplarily, the SMF-2 can obtain the information of the SMF-1 from the VN management network clement by active inquiry, or alternatively, by passive notification where the VN management network node can be configured to proactively send out notifications to the SMF-1 or other pre-existing SMFs without being requested when an SMF, such as SMF-2, becomes newly active in the VN group communication and registers the information of the SMF-2 and the VN ID to the VN management network node. That is, the VN management network node can notify active SMFs associated with the same VN ID as that of the SMF-2, such as the SMF-1 here, of the registration/addition of the information of the SMF-2 and the corresponding VN ID into the VN management network node, once such additional SMF information of SMF-2 associated with the VN ID is provided/registered/saved to the VN management network node. The VN management network node may be implemented in any manner as part of the core network. It may be implemented as a newly configured function or as part of existing function of the core network. For example, it may be implemented as part of a Network function Repository Function (NRF), a Unified Data Repository (UDR), or a Unified Data Management (UDM) of the wireless core network. One or more of these network nodes may be configured to perform the function of the maintaining VN group communication registration and records, and notification, as described above.

In one embodiment, the information of the SMF-2 can be provided in a list among a plurality pieces of information of a plurality of SMFs under the same network. For example, the SMF-1, when attempting to establish a new PDU session for VN communication can make an inquiry to the VN management network node, and the VN management network node can return a list of SMFs existing (actively registered) under the same VN based on the VN ID. Alternatively, the VN management network node can also notify an SMF, when another SMF is trying to establish a new PDU session for communication in the same VN, of the list of active SMFs of same VN. Because a SMF provides the VN ID and its SMF information (such as identification information) to the VN management network node when registering, VN management network node can easily look up the existing SMFs associated with the same VN ID.

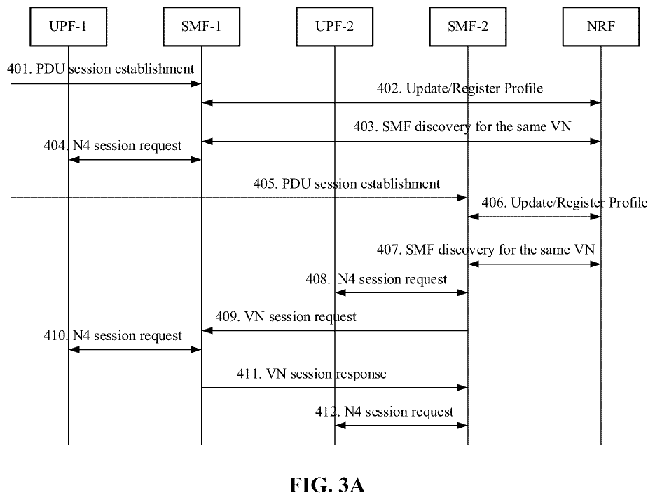

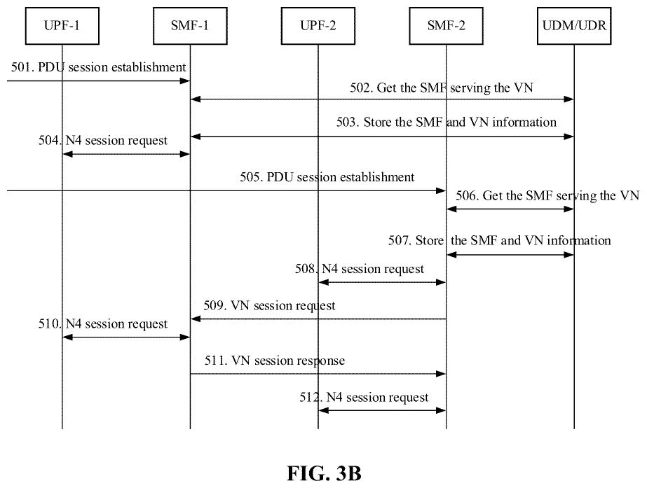

FIG. 3A shows an example signal flow among various core network components for a wireless virtual network according to an embodiment of this disclosure. The signal flow can be performed by the wireless communication systems of FIGS. 2A and 2B. Using the system in FIG. 2A as an example, the signal flow may include the following example steps. These steps may not need to performed in described order unless specifically indicated.

401. Receiving, by the SMF-1, a PDU session establishment request. In this step, the SMF-1 receives a PDU session establishment request. The request may be initiated at a UE and transmitted from an Access and Mobility Management Function (AMF) or an Intermediate SMF (iSMF) or a Visited SMF (vSMF). For example, a UE can send a request, and the request can travel through an AMF and then to the SMF-1. A request can also travel from a UE, an AMF, an intermediate SMF, and then to the SMF-1. Additionally, a request can also travel from a UE, an AMF, an visited SMF, and then to the SMF-1. According to the information in the request, such as Data Network Name (DNN) and/or Single Network Slice Selection Assistance Information (S-NSSAI), the SMF-1 may ascertain that this PDU session is to be established for a certain VN group.

402. Updating, by the SMF-1, information of the SMF-1 and/or the VN ID to the VN management network node, such as an NRF shown in FIG. 3A. The SMF-1 may update or register its profile to the NRF, such as information that can identify the SMF-1. The information of the SMF-1 may include at least one of an SMF ID or an SMF URI) and VN ID (including e.g. at least one of internal group ID, DNN/S-NSSAI, a shared VN Group Data ID, or a new VN group ID value). A shared VN Group Data ID can be an existing virtual network group data identifier, used to identify a specific virtual network. Alternative, the wireless communication system can create a new identifier, the new VN group ID value, to identify the virtual network.

403. Discovering one or more SMFs associated with the same VN based on the VN ID. According to this step, the SMF-1 uses the VN ID of the VN group it serves to look up the record of the NRF (as the VN management network node) to determine whether there is another SMF or a plurality of SMFs actively serving the same VN group. The SMF-1 may send a request/inquiry to the NRF, and the NRF may return a list of the SMFs related to this VN group in response. In the situation where there has not been another other actively registered SMFs serving this VN group, such as here, the NRF may return null because the SMF-1 is the first SMF serving the instant VN. If there are other actively registered SMFs in the list returned by NRF, the SMF-1 may send VN session requests to one or more or all of these other SMFs under the same VN to establish data communication tunnel between the underneath UPFs.

It should be noted that step 402 and step 403 can be performed in any order. That is, the step 403 may be performed before step 402, alternative step 402 may precede step 403. Additionally, steps 402 and 403 may be performed by using one request and response. For example, the SMF-1 may embed an update request of the information of the SMF-1 (along with its VN ID) and inquiry of other SMFs under the same VN in the same request.

404. Sending an N4 session request to configure the PDU session and configure the PDR/FAR of the UPF. The SMF-1 then sends the UPF-1 a request to configure the UPF-1 and establish the PDU session. The SMF-1 may configure the PDR/FAR for this PDU session according to the current status.

405. Receiving, by SMF-2, a PDU session establishment request. In this step, the SMF-2 receives a PDU session establishment request associated with a UE. The request may be transmitted from an AMF or an iSMF or a vSMF. According to the information in the request, such as the DNN/S-NSSAI, the SMF-2 may determine that this PDU session is to be established for a certain VN group.

406. Updating or registering its profile (such as the information of the SMF-2 and VN ID) to the NRF by the SMF-2. The information of the SMF-2 may include a SMF ID or a SMF URI, and the VN ID may include a shared VN Group Data ID, or a new VN group ID value, an internal group ID, or DNN/S-NSSAI. The NRF can understand that SMF-1 and SMF-2 are associated to the same VN based on the VN ID they reported to the NRF.

407. Discovering one or more SMFs associated with the same VN by the SMF-2. Like the step 403, the SMF-2 provides the VN ID of the VN group it serves to look up the record of the NRF to determine whether there is another SMF or a plurality of SMFs actively serving the same VN group. For example, The SMF-2 may send a request to the NRF, and the NRF may return the SMF list related to the same VN ID in response. Because SMF-1 has already registered and provided the information of the SMF-1 and the associated VN ID to the NRF (functioning as the VN management network node), the SMF-2 can use the information stored at the NRF to determine that SMF-1 is another SMF serving the same VN. The information of the SMF-1 possessed by the NRF may include some form of identity of the SMF-1. As such, the SMF-2 can use the information to track down the SMF-1.

408. Configuring the PDR/FAR of the UPF-2 by the SMF-2 and requesting the UPF-2 to allocate the data communication tunnel resource corresponding to data communication tunnel information. In this embodiment, the SMF-2 then can use the information of the SMF-1 to configure the PDR (packet detection rule) and/or FAR (forwarding action rule) of the UPF-2, such that the UPF-2 can properly relay data packets to their destinations. For example, the data packets may be relayed to the UPF-1 if the data packets designated the UE-1 or UE-2 under the UPF-1 as a recipient of the data packets. Further, the SMF-2 can also request the UPF-2 to allocate data communication tunnel resource corresponding to a data communication tunnel information for an N19 data communication tunnel for VN communication across UPFs. The data communication tunnel information may include a Tunnel Endpoint Identifier (TEID) or a Fully Qualified Tunnel Endpoint Identifier (F-TEID).

409. Sending a VN session request to SMF-1. The SMF-2 then sends a VN session request to the SMF-1, and the request may include the UPF-2 data communication tunnel information. The request can establish a data communication tunnel between the SMF-1 and SMF-2. It can also serve as a command to establish the data communication tunnel between the UPF-1 and the UPF-2.

410. Sending, by SMF-1, the received data communication tunnel information of UPF-2 to UPF-1 and request UPF-1 to allocate the tunnel resource according to the received tunnel information by the SMF-1. After received the VN session request, including the data communication tunnel information, from SMF-2, the SMF-1 can forward the data communication tunnel information of UPF-2 to the UPF-1. The information can be used to request the UPF-1 to allocated proper tunnel recourse according to the UPF-2 data communication tunnel information for the to-be-established data communication tunnel between UPF-1 and UPF-2. The UPF-1 may return a UPF-1 data communication tunnel information corresponding to the allocated UPF-1 resource to the SMF-1.

411. Sending a VN session response to SMF-2, in the response, by the SMF-1, wherein the data communication tunnel information of the UPF-1 is included. After the SMF-1 confirms that the UPF-1 has allocated the proper tunnel resource, the SMF-1 can send a response, including the tunnel information corresponding to the tunnel resource allocated by the UPF-1, to SMF-2, such that the UPF-2 can establish the N19 data communication tunnel with the UPF-1.

412. Sending a N4 request to UPF-2 by SMF-2 to inform the UPF-2 of the tunnel information corresponding to the allocated tunnel resource in the UPF-1. By step 412, the UPF-2 can obtain the tunnel information corresponding to the allocated tunnel resource in the UPF-1, so the N19 data communication tunnel between the UPF-1 and UPF-2 can be established.

As such, with the information of the SMFs actively serving the same VN, an SMF can configure its UPF's PDR/FAR and allocate proper tunnel resource to establish a data communication tunnel with the existing one or more UPFs under the same VN. Therefore, a VN with multiple SMFs can be implemented, and the geographic limitation of the single SMF VN under the current 5G system can be resolved.

FIG. 3B shows another example signal flow among various core network components for a wireless virtual network according to an embodiment of this disclosure. The signal flow can be performed by the wireless communication systems of FIGS. 2A and 2B. Using the system in FIG. 2A as an example, the signal flow may include the following steps. These steps may not need to performed in described order unless specifically indicated.

501. Receiving a PDU session establishment request. In this step, the SMF-1 receives a PDU session establishment request associated with a UE. The request may be transmitted from an AMF or an iSMF or an vSMF. According to the information in the request, such as Data Network Name (DNN) and/or Single Network Slice Selection Assistance Information (S-NSSAI), the SMF-1 may determine that this PDU session is to be established for a certain VN group.

502. Obtain information showing one or more SMFs are associated with the same VN from the UDM or UDR acting as the VN management network node. According to this step, the SMF-1 uses the VN ID of the VN group it serves to look up the record of the UDM or UDR to determine whether there is another SMF serving the same VN group. For obtaining such information from UDM, the SMF-1 may invoke Nudm_UECM_Get (VN ID) service operation, and the UDM may return the SMF list related to this VN group. For obtaining such information from UDR, the SMF may obtain the information form the UDR via a Policy Control Function (PCF), UDM or NRF using the various mechanism. In the situation where there has not been another other actively registered SMFs serving this VN group, such as here, the UDM or UDR may return null because the SMF-1 is the first SMF serving the instant VN.

503. Updating information of the SMF-1 and/or the VN ID to the VN management network node, such as the UDR/UDM. The SMF-1 may update or store its profile to the UDR or UDM, such as its information that may identify the SMF-1. The information of the SMF-1 may include at least one of an SMF ID or an SMF URI) and VN ID (including e.g. at least one of internal group ID, DNN/S-NSSAI, a shared VN Group Data ID, or a new VN group ID value).

It should be noted that step 502 and step 503 can be performed in any order. That is, the step 503 may be performed before step 502, alternative step 502 may precede step 503. Additionally, steps 502 and 503 may be performed by using one request and response. For example, the SMF-1 may embed an update request of the information of the SMF-1 and inquiry of other SMFs under the same VN in the same request.

504. Sending a N4 session request to configure the PDU session and configure the

PDR/FAR of the UPF. The SMF-1 then sends a request to configure the UPF-1 and establish the PDU session. The SMF-1 may configure the PDR/FAR for this PDU session according to the current status. The step 504 is similar to the step 404, so the details are omitted here.

505. Receiving a PDU session establishment request by SMF-2. In this step, the SMF-2 receives a PDU session establishment request associated with a UE. The request may be transmitted from an AMF or iSMF or a vSMF. According to the information in the request, such as a DNN/S-NSSAI, the SMF-2 may determine that this PDU session is to be established for a certain VN group.

506. Discovering one or more SMFs associated with the same VN by the SMF-2. Like the step 503, the SMF-2 uses the VN ID of the VN group it serves to look up the record of the UDM or UDR to determine whether there is another SMF or a plurality of SMFs actively serving the same VN group. For example, the SMF2 may invoke a Nudm_UECM_Get (VN ID) service operation to UDM, and the UDM may return the SMF list related to this VN group. For obtaining the information from UDR, the SMF may obtain the information from the UDR via a PCF, UDM or Network Exposure Function (NEF) using the various mechanism. Because SMF-1 has already registered and provided the information of the SMF-1 and the associated VN ID to the UDM or UDR, the SMF-2 can use the information stored at the UDM or UDR to determine that SMF-1 is another SMF actively serving the same VN. The information of the SMF-1 possessed by the UDM or NEF may include some form of identity of the SMF-1. As such, the SMF-2 can use the information to track down the SMF-1.

507. Updating or storing information of the SMF-2 and/or the VN ID to the VN management network node, such as the UDR/UDM. The information of the SMF-2 may include a SMF ID or a SMF URI, and the VN ID may include an internal group ID, DNN/S-NSSAI, a shared VN Group Data ID, or a new VN group ID value. By the information, the NRF can understand that SMF-1 and SMF-2 are associated to the same VN based on the VN ID they reported to the NRF. Again, the step 507 can be performed before the step 506.

508. Configuring the PDR/FAR of the UPF-2 by the SMF-2 and requesting the UPF-2 to allocate the data communication tunnel resource corresponding to data communication tunnel information. In this embodiment, the SMF-2 then can use the information of the SMF-1 to configure the PDR and FAR of the UPF-2, such that the UPF-2 can properly relay the data packet to their destinations. For example, the data packets may be relayed to the UPF-1 if a data packet designates the UE-1 or UE-2 under the UPF-1 as a recipient of the data packets. Further, the SMF-2 can also request the UPF-2 allocate tunnel resource corresponding to a data communication tunnel information for an N19 data communication tunnel for VN communication across UPFs. The tunnel information may include a Tunnel Endpoint Identifier (TEID) or a Fully Qualified Tunnel Endpoint Identifier (F-TEID).

509. Sending a VN session request to SMF-1. The SMF-2 then sends a VN session request to the SMF-1, and the request may include the UPF-2 data communication tunnel information. The request can establish a data communication tunnel between the SMF-1 and SMF-2. It can also serve as a command to establish the data communication tunnel between the UPF-1 and the UPF-2.

510. Sending the received tunnel information to UPF-1 and request UPF-1 to allocate the data communication tunnel resource according to the received data communication tunnel information by the SMF-1. After received the VN session request, including the UPF-2 data communication tunnel information, from SMF-2, the SMF-1 can forward the data communication tunnel information of UPF-2 to UPF-1. The information can be used to request the UPF-1 to allocated proper tunnel recourse according to the UPF-2 data communication tunnel information for the to-be-established data communication tunnel between UPF-1 and UPF-2. The UPF-1 may return a UPF-1 data communication tunnel information corresponding to the allocated UPF-1 resource to the SMF-1.

511. Sending a VN session response to SMF-2, in the response, by the SMF-1, wherein the tunnel resource of UPF-1 is included. After SMF-1 confirms that the UPF-1 has allocated the proper tunnel resource, the SMF-1 can send a response, including the tunnel information corresponding to the tunnel resource allocated by the UPF-1, such that the UPF-2 can establish the N19 data communication tunnel with the UPF-1.

512. Sending a N4 request to UPF-2 by SMF-2 to inform the UPF-2 of the tunnel information corresponding to the allocated tunnel resource in the UPF-1. By step 512, the UPF-2 can obtain the tunnel information corresponding to the allocated tunnel resource in the UPF-1, so the N19 data communication tunnel between the UPF-1 and UPF-2 can be established.

As such, with the information of the SMFs actively serving the same VN, an SMF can configure its UPF's PDR/FAR and can allocate proper resource to establish a data communication tunnel with the existing one or more UPFs within the same VN. Therefore, a VN with multiple SMFs can be implemented, and the geographic limitation of the single SMF VN under the current 5G system can be resolved.

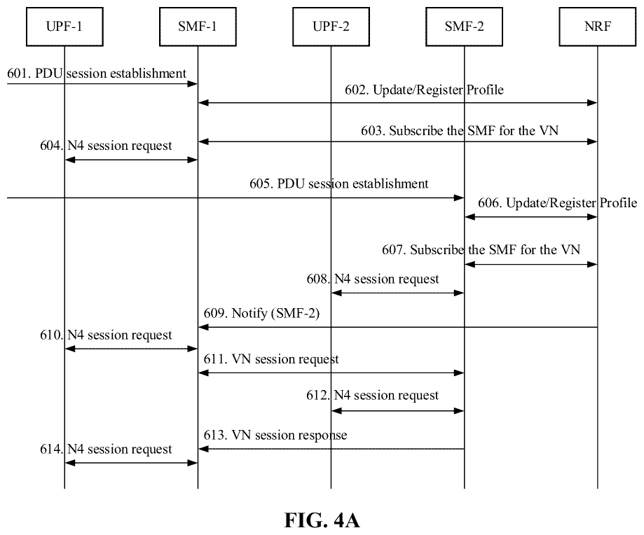

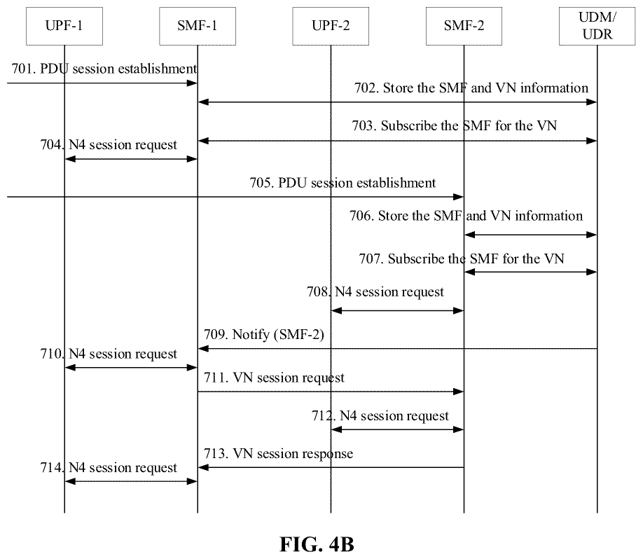

FIG. 4A shows another example signal flow among various core network components for a wireless virtual network according to an embodiment of this disclosure. The signal flow can be performed by the wireless communication systems of FIGS. 2A and 2B. Using the system in FIG. 2A as an example, the signal flow may include the following steps. These steps may not need to performed in described order unless specifically indicated.

601. Receiving a PDU session establishment request by the SMF-1. In this step, the SMF-1 receives a PDU session establishment request. The request may be initiated at a UE and transmitted from an AMF, an iSMF, or a vSMF. AMF or an iSMF, or a vSMF, the SMF-1 may know this PDU session is to be established for a certain VN group.

602. Updating information of the SMF-1 and/or the VN ID to the VN management network node, such as an NRF. The SMF-1 may update or register to the NRF its profile, such as its information that may identify the SMF-1. The information of the SMF-1 may include at least one of an SMF ID or an SMF URI) or VN ID (including e.g. at least one of internal group ID, DNN/S-NSSAI, a shared VN Group Data ID, or a new VN group ID value).

603. Subscribing to a service function for notification of information of newly enrolled SMF under the same VN by SMF-1 for actively serving the VN. In this step, the SMF-1 can use its VN ID to subscribe to a service function of the VN management network node, such as an NRF. Thereby, once there is a newly enrolled SMF to the same VN, the VN management network node will notify a SMF that has subscribed to this service function, such as the SMF-1 here. The step 603 can be performed ahead of the step 602.

604. Sending an N4 session request to configure the PDU session and configure the PDR/FAR of the UPF. In this step, the SMF-1 then sends a request to configure the UPF-1 and establish the PDU session. The SMF-1 may configure the PDR/FAR for this PDU session according to the current status.

605. Receiving a PDU session establishment request by SMF-2. In this step, the SMF-2 receives a PDU session establishment request associated with a UE. The request may be transmitted from an AMF, an iSMF, or a vSMF. According to the information in the request, such as a DNN/S-NSSAI, the SMF-2 may determine that this PDU session is to be established for a certain VN group.

606. Updating or registering its profile (e.g., the information of the SMF-2 and VN ID) to the NRF by the SMF-2. The information of the SMF-2 may include a SMF ID or a SMF URI, and the VN ID may include an internal group ID, DNN/S-NSSAI, a shared VN Group Data ID, or a new VN group ID value. The NRF can understand that SMF-1 and SMF-2 are associated to the same VN based on the VN ID they reported to the NRF.

607. Subscribing to a service function for notification of information of newly enrolled SMFs under the same VN by the SMF-2. In this step, the SMF-2 can use its VN ID to subscribe to a service function of the VN management network node, such as an NRF. Thereby, once there is a newly enrolled SMF to the same VN, the VN management network node would notify the SMF, which has subscribed to this service function, such as SMF-2. The step 607 can be performed ahead of the step 606.

608. Sending an N4 session request to configure the PDU session and configure the PDR/FAR of the UPF-2 by SMF-2. The SMF-2 then sends a request to configure the UPF-2 and establish the PDU session. The SMF-2 may configure the PDR/FAR for this PDU session according to the current status.

609. Receiving a notification from the VN management network node by the SMF-1 of the enrollment of the SMF-2. Because SMF-1 has subscribed to the notification service, the NRF may send a notification in response to SMF-2 enrolling into the same VN. The notification may include the information of the SMF-2 and the VN ID, which are provided by the SMF-2 in the previous step.

610. Configuring the PDR/FAR of the UPF-1 by the SMF-1 and requesting the UPF-1 to allocate the data communication tunnel resource. After the SMF-1 obtains the information of the newly enrolled SMF-2, the SMF-1 then can use the information of the SMF-2 to configure the PDR and FAR of the UPF-2, such that the UPF-1 can properly relay data packets to the UPF-2 if the data packets designate the UE-3 or UE-4 under the UPF-2 as the recipient of the data packets. Further, the SMF-1 can also request the UPF-1 to allocate data communication tunnel resource for an N19 data communication tunnel, and return a UPF-1 data communication tunnel information. The UPF-1 data communication tunnel information may include a Tunnel Endpoint Identifier (TEID) or a Fully Qualified Tunnel Endpoint Identifier (F-TEID).

611. Sending a VN session request to SMF-2. The SMF-1 then sends a VN session request to the SMF-2. The VN session request can include the UPF-1 data communication tunnel information. The VN session request can establish a data communication tunnel between the SMF-1 and SMF-2. It can also serve as a command to establish the data communication tunnel between the UPF-1 and the UPF-2.

612. Sending the received tunnel information to UPF-2 and requesting UPF-2 to allocate the tunnel resource according to the received tunnel information by the SMF-2. After receiving the VN session request, including the UPF-1 data communication tunnel information from SMF-1, the SMF-2 can forward the tunnel information to UPF-2. The information can be used to request the UPF-2 to allocate proper tunnel recourse according to the UPF-1 data communication tunnel information of the UPF1 for the to-be-established data communication tunnel between UPF-1 and UPF-2. The UPF-2 may return a UPF-2 data communication tunnel information to the SMF-2.

613. Sending a VN session response to SMF-1 by the SMF-2, wherein the UPF-2 data communication tunnel information is included in the response. After the SMF-2 confirms that the UPF-2 has allocated the proper tunnel resource, the SMF-2 can send a response, including the UPF-2 data communication tunnel information corresponding to the tunnel resource allocated by the UPF-2, such that the UPF-1 can establish the N19 data communication tunnel with the UPF-2 accordingly.

614. Sending a N4 request to UPF-1 by SMF-1 to inform the UPF-1 of the UPF-2 data communication tunnel information corresponding to the allocated tunnel resource in the UPF-2. By the step 614, the UPF-1 can obtain the UPF-2 data communication tunnel information corresponding to the allocated tunnel resource in the UPF-2, so the N19 data communication tunnel between the UPF-1 and UPF-2 can be established.

As such, with the information of the newly enrolled SMFs within the same VN, an SMF can configure its UPF's PDR/FAR, and allocate proper resource to establish a data communication tunnel with the existing one or more UPFs within the same VN. In this embodiment, the information is provided to an existing SMF when there is any newly enrolled SMFs after the existing SMF subscribes to the notification service function of a VN management network node. Therefore, a VN with multiple SMFs can be implemented, and the geographic limitation of the single SMF VN under the current 5G system can be resolved.

FIG. 4B shows another example signal flow among various core network components for a wireless virtual network according to an embodiment of this disclosure. The signal flow can be performed by the wireless communication systems of FIGS. 2A and 2B. Using the system in FIG. 2A as an example, the singal flow may include the following steps. These steps may not need to performed in described order unless specifically indicated.

701. Receiving a PDU session establishment request by the SMF-1. In this step, the SMF-1 receives a PDU session establishment request. The request may be initiated at a UE and transmitted from an AMF, an iSMF, or a vSMF. According to the information in the request, such as a DNN/S-NSSAI, the SMF-1 may determine that this PDU session is to be established for a certain VN group.

702. Updating or storing information of the SMF-1 and/or the VN ID to a VN management network node, such as the UDR/UDM serving as the VN management network node. The SMF-1 may update or store to the UDR or UDM its profile, such as its information that may identify the SMF-1. The information of the SMF-1 may include at least one of an SMF ID or an SMF URI and VN ID (including e.g. at least one of internal group ID, DNN/S-NSSAI, a shared VN Group Data ID, or a new VN group ID value).

703. Subscribing to a service function for notification of information of newly enrolled SMF under the same VN by SMF-1. In this step, the SMF-1 can use its VN ID to subscribe to a service function of the VN management network node, such as the UDR or UDM. Thereby, once there is a newly enrolled SMF to the same VN, the VN management network node will notify the SMF, such as the SMF-1, which has subscribed to this service function. The step 703 can be performed ahead of the step 702.

704. Sending an N4 session request to configure the PDU session and configure the PDR/FAR of the UPF. The SMF-1 then sends a N4 session request to configure the UPF-1 and establish the PDU session. The SMF-1 may configure the PDR/FAR for this PDU session according to the current status.

705. Receiving a PDU session establishment request by SMF-2. In this step, the SMF-2 receives a PDU session establishment request. The request may be transmitted from an AMF, an iSMF, or a vSMF. According to the information in the request, such as a DNN/S-NSSAI, the SMF-2 may know this PDU session is to be established for a certain VN group.

706. Updating or storing information of the SMF-2 and/or the VN ID to the VN management network node, such as the UDR/UDM. The information of the SMF-2 may include a SMF ID or a SMF URI, and the VN ID may include an internal group ID, or DNN/S-NSSAI. By the information, the UDR/UDM can understand that SMF-1 and SMF-2 are associated to the same VN based on the VN ID they reported to the UDR/UDM.

707. Subscribing to a service function for notification of information of newly enrolled SMF under the same VN by SMF-2. In this step, the SMF-2 can use its VN ID to subscribe to a service function of the VN management network node, such as the UDR/UDM, such that once there is a newly enrolled SMF to the same VN. The VN management network node will notify the SMF (such as the SMF-2), which has subscribed to this service function. The step 707 can be performed a head of the step 706.

708. Sending an N4 session request to configure the PDU session and configure the PDR/FAR of the UPF by SMF-2. The SMF-2 then sends a request to configure the UPF-2 and establish the PDU session. The SMF-2 may configure the PDR/FAR for this PDU session according to the current status.

709. Receiving a notification from the VN management network node by the SMF-1 of the enrollment of the SMF-2. Because SMF-1 has subscribed to the notification service, the NRF may send a notification in response to the SMF-2 enrolling into the same VN. The notification may include the information of the SMF-2 and the VN ID, which are provided by the SMF-2 in the previous step.

710. Configuring the PDR/FAR of the UPF-1 by the SMF-1 and requesting the UPF-1 to allocate the tunnel resource. After the SMF-1 obtains the information of the newly enrolled SMF-2, the SMF-1 then can use the information of the SMF-2 to configure the PDR and FAR of the UPF-2, such that the UPF-1 can properly relay data packets to their destinations. For example, the data packets may be relayed to the UPF-2 if the data packets designate the UE-3 or UE-4 under the UPF-2 as the recipient of the data packets. Further, the SMF-1 can also request the UPF-1 to allocate tunnel resource for an N19 data communication tunnel for VN communication across UPFs. The UPF-1 may return a UPF-1 data communication tunnel information corresponding to the allocated tunnel resource. The UPF-1 data communication tunnel information may include a Tunnel Endpoint Identifier (TEID) or a Fully Qualified Tunnel Endpoint Identifier (F-TEID).

711. Sending a VN session request to SMF-2. The SMF-1 then sends a VN session request to the SMF-2, and the request can include the UPF-1 data communication tunnel information. The request can establish a data communication tunnel between the SMF-1 and SMF-2. It can also serve as a command to establish the data communication tunnel between the UPF-1 and the UPF-2.

712. Sending the received UPF-1 data communication tunnel information to UPF-2 and request UPF-2 to allocate the tunnel resource according to the received tunnel information by the SMF-2. After received the VN session request, including the UPF-1 data communication tunnel information, from SMF-1, the SMF-2 can forward the tunnel information to UPF-2. The information can be used to request the UPF-2 to allocated proper tunnel recourse according to the tunnel recourse information of the UPF1 for the to-be-established data communication tunnel between UPF-1 and UPF-2. The UPF-2 may return UPF-2 data communication tunnel information corresponding the allocated tunnel resource to SMF-2.

713. Sending a VN session response to SMF-1 by the SMF-2. After SMF-2 confirms that the UPF-2 has allocated the proper tunnel resource, the SMF-2 can send a response, including the UPF-2 data communication tunnel information corresponding to the tunnel resource allocated by the UPF-2, such that the UPF-1 can establish the N19 data communication tunnel with the UPF-2.

714. Sending a N4 request to UPF-1 by SMF-1 to inform the UPF-1 of the UPF-2 data communication tunnel information corresponding to the allocated tunnel resource in the UPF-2. By the step 714, the UPF-1 can obtain the UPF-2 data communication tunnel information corresponding to the allocated tunnel resource in the UPF-2, so the N19 data communication tunnel between the UPF-1 and UPF-2 can be established.

As such, with the information of the newly enrolled SMFs within the same VN, an SMF can configure its UPF's PDR/FAR, and allocate proper resource to establish a data communication tunnel with the existing one or more UPFs with the same VN. In this embodiment, the information is provided to an existing SMF when there is any newly enrolled SMFs after the existing SMF subscribes to the notification service function of a VN management network node. Therefore, a VN with multiple SMFs can be implemented, and the geographic limitation of the single SMF VN under the current 5G system can be resolved.

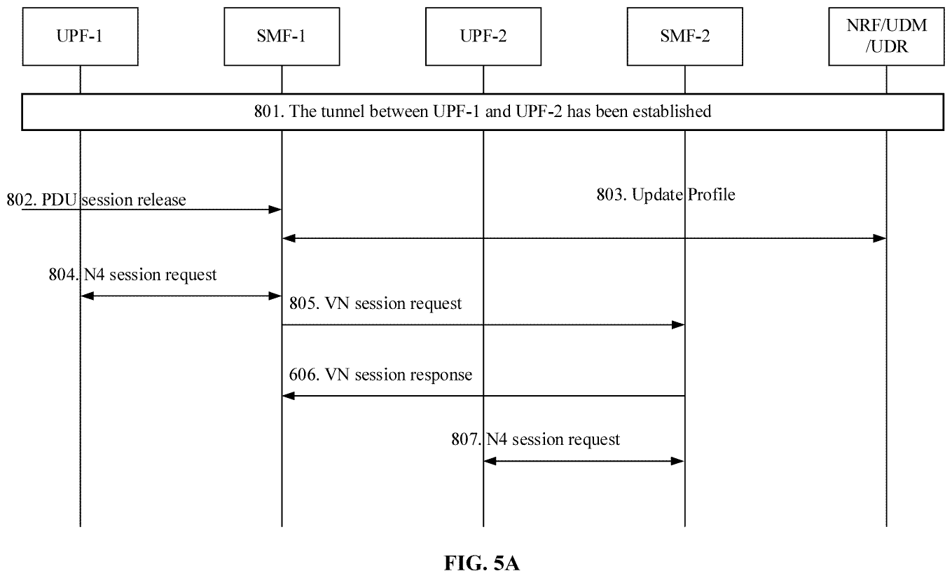

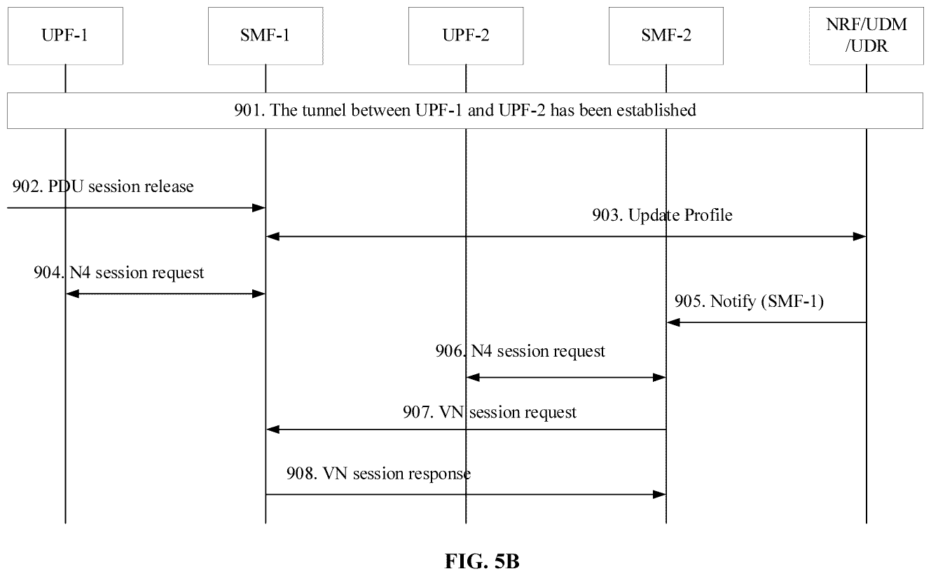

FIG. 5A shows another example signal flow among various core network components for a wireless virtual network according to an embodiment of this disclosure. The signal flow can be performed by the wireless communication systems of FIGS. 2A and 2B. Using the system in FIG. 2A as an example, the signal flow may include the following steps. These steps may not need to performed in described order unless specifically indicated.

801. Establishing a VN session between a SMF-1 and a SMF-2 and a data communication tunnel between a UPF-1 configured by or associated with the SMF-1 and a UPF-2 configured by or associated with the SMF-2. As shown in FIG. 2A, the PDU session has been established under the SMF-1 and the SMF-2, and correspondingly a VN session is established between the SMF-1 and SMF-2. Further, an N19 data communication tunnel is established between the UPF-1 configured by or associated with the SMF-1 and the UPF-2 configured by or associated with SMF-2.

802. Receiving a PDU session release request by SMF-1. The SMF-1 receives a PDU session release request. The request may be transmitted from an AMF, an iSMF, or a vSMF. According to the information in the request, the SMF-1 controls the UPF-1 to release the corresponding PDU session between a UE and the UPF-1.

803. Updating SMF information in a VN management network node, such as a NRF, URM, or UDR, to remove the SMF-1 information for the VN communication. After the request of the release has been performed, the SMF-1 may determine all the PDU sessions for the VN under the SMF-1 have been released. In response, the SMF-1 updates its SMF information for the VN possessed by the NRF, URM, or UDR. For example, it can remove the information of the SMF-1 from the list, maintained by the NRF, URM, or UDR, of the SMFs under the same VN. The instruction between the SMF-1 and the UDR can be performed by PCF, UDM, or NEF.

804. Requesting, by the SMF-1, the UPF-1 to release the resource for the data communication tunnel between UPF-1 and UPF-2. Once the SMF-1 determines that there is no UE maintaining PDU sessions with the UPF-1, the SMF-1 can control the UPF-1 to release the resource of the UPF-I used for the data communication tunnel between the UPF-1 and UPF-2.

805. Sending a VN session release request, by the SMF-1, to SMF-2 to release the VN session. Because there is no further PDU sessions maintained by the SMF-1, the SMF-1 may send a request to the SMF-2 to coordinate the release of the VN sessions.

806. Sending a VN session release response, by the SMF-2, to SMF-1 to confirm the release. In response, the SMF-2 may send the VN session release response once it confirms that the VN sessions between the SMF-1 and the SMF-2 has been released.

807. Requesting, by the SMF-2, the UPF-2 to release the resource of the UPF-2 for the data communication tunnel between UPF-1 and UPF-2.

According to the steps above, once the PDU sessions of a SMF are all released, the corresponding resource maintained for these PDU sessions can be released. The allocation of the resources can therefore be more efficient.

FIG. 5B shows another example signal flow among various core network components for a wireless virtual network according to an embodiment of this disclosure. The signal flow can be performed by the wireless communication systems of FIGS. 2A and 2B. Using the system in FIG. 2A as an example, the signal flows may include the following steps. These steps may not need to performed in described order unless specifically indicated.

901. Establishing a VN session between a SMF-1 and a SMF-2 and a data communication tunnel between a UPF-1 configured by or associated with the SMF-1 and a UPF-2 configured by or associated with the SMF-2. As shown in FIG. 2A, the PDU session has been established under the SMF-1 and the SMF-2, and correspondingly a VN session is established between SMF-1 and SMF-2. Further, an N19 data communication tunnel is established between the UPF-1 configured by or associated with the SMF-1 and the UPF-2 configured by or associated with SMF-2.

902. Receiving the PDU session release request by SMF-1. The SMF-1 receives a PDU session release request. The request may be transmitted from an AMF, an iSMF, or a vSMF. According to the information in the request, the SMF-1 controls the UPF-1 to release the corresponding PDU session between a UE and the UPF-1.

903. Updating SMF information in a VN management network node, such as a NRF, URM, or UDR, to remove the SMF information for the VN. After the request to release has been performed, the SMF-1 may determine all the PDU sessions for the VN under the SMF-1 have been released. In response, the SMF-1 updates its SMF information possessed by the NRF, URM, or UDR. For example, it can remove the information of the SMF-1 from the list, maintained by the NRF, URM, or UDR, of the SMFs under the same VN. The instruction between the SMF-1 and the UDR can be performed by PCF, UDM, or NEF.

904. Requesting, by the SMF-1, the UPF-1 to release the resource for the data communication tunnel between UPF-1 and UPF-2. Once the SMF-1 determines there is no UE maintaining PDU sessions with the UPF-1, the SMF-1 can control the UPF-1 to release the resource of the UPF-1 used for the data communication tunnel between the UPF-1 and UPF-2.

905. Sending, by the VN management network node, a notification of the removal of the SMF-1 from the VN to the SMF-2. In this embodiment, because the SMF-2 subscribed to the notification service, which provides notification in response the update of the registered or stored SMF information serving the same VN, the VN management network node, such as an NRF, UDM, or UDR, sends a notification to the SMF-2. Thereby, the SMF-2 can obtain the information of the SMF-1′s removal.

906. Requesting, by the SMF-2, the UPF-2 to release the resource of the UPF-2 for the data communication tunnel between UPF-1 and UPF-2.

907. Sending a VN session release request, by the SMF-2, to SMF-1 to release the VN session. Because there is no further PDU sessions maintained by the SMF-1, the SMF-2 may send a request to the SMF-1 to coordinate the release of the VN sessions between SMF-1 and SMF-2 once the SMF-2 obtain the SMF-1′s removal information based on the notification from the VN management network node.

908. Sending a VN session release response, by the SMF-1, to SMF-2 to confirm the release. In response to the request sent in step 907, the SMF-1 may send the VN session release response once it confirms that the VN sessions between the SMF-1 and the SMF-2 has been released.

According to the steps above, once the PDU sessions are all released, the corresponding resource maintained for these PDU sessions can be released. The allocation of the resource can be more efficient.

### Data Transmission Configuration

Referring to FIG. 2A, when the UPF-1 receives a data packet designated to be sent to another UE, such as UE-3, from UE-1, the UPF-1 may need some rules to relay the data packet. To enable the data packet forwarding process, such as the local data switching, the inter-UPF data forwarding, and UPF-to-DN data forwarding mentioned above, the SMF shall configure the UPF's PDR (packet detection rule) and/or FAR (forwarding action rule). For example, under the topology as shown in FIG. 2A, the SMF-1 may configure the UPF-1 to have PDR1/FAR1 (for inbound transmission) and PDR2/FAR2 (for outbound transmission) for the transmission of UE-1. The PDR1 may be used to detect that packets belonging to the VN and targeting UE-1, and the FAR1 may be used to forwarding the data packets to UE-1. Further, the PDR2 can be used to detect data packets from UE-1, and the FAR2 (which may include a plurality of rules) can be used to forward the data packets to the specific UE, such as UE-2, the inter UPF interface (e.g., N19 interface), or the UPF-to-DN interface (e.g., N6 interface). Additionally for the transmission to UE-1, the SMF-2 may configure the UPF-2 with PDR3/FAR4. The PDR3 can be used to detect data packets belonging to the VN and targeting to a UE-1, and the FAR3 can be used to direct the data packets to the N19 interface to be forwarded to the UPF-1 and then UE-1.

In a VN with multiple SMFs, a SMF needs to obtain certain information to configure the PDR and/or FAR, such that the UPF configured by or associated with the SMF can forward the received data packets according to the network nodes under different SMFs.

Therefore, when a SMF-1 determines to establish a VN session with a SMF-2, it may request UPF-1 configured by and associated with the SMF-1 to allocate UPF-1 data communication tunnel information (such as a Fully Qualified Tunnel Endpoint Identifier (F-TEID), including IP address and/or port and tunnel identifier (TEID) for receiving data packets). Additionally, the SMF-1 may send an VN session request to the SMF-2. The VN session request may include at least one of an VN ID, the UPF-1 data communication tunnel information, or SMF-1 routing information.

When SMF-2 receives the VN session request from the SMF-1, the SMF-2 may send the UPF-1 data communication tunnel information the UPF-2, and request UPF-2 to allocate UPF-2 data communication tunnel information (likewise including F-TEID, such as IP address and/or port and tunnel identifier (TEID) for receiving data packets). The SMF-2 can further prepare PDR and/or FAR for the UPF-2 according to the SMF-1 routing information and send to UPF-2 to configure UPF-2 according to the prepared PDR and/or FAR. In response, the SMF-2 sends VN session response, including the VN ID, the UPF-2 data communication tunnel information allocated by the UPF-2, and SMF-2 routing information to the SMF-1.

After the SMF-1 receives the VE session response from the SMF-2, SMF-1 may provide UPF-2 data communication tunnel information to UPF-1, such that the UPF-1 can establish the data communication tunnel with UPF-2 according to the UPF-2 data communication tunnel information. The SMF-1 also prepares PDR and/or FAR according to the SMF-2 routing information and sends the PDR/FAR to the UPF-1 to configure UPF-1.

Additionally, according to an embodiment of this disclosure, SMF-1 (or SMF-2 vise versa) may update the VN session with SMF-2 (or other SMFs) by the following steps. SMF-1 may send a VN session update request to SMF-2. The VN session update request may include an VN ID and updated SMF-1 Routing information. When the SMF-2 receives the VN session update request from SMF-1, it may update the PDR and/or FAR for the UPF-2 configured by or associated with the SMF-2 according to the SMF-1 routing information in order to configure the UPF-2 according to the updated PDF and/or FAR. The updated PDR/FAR may be a new PDR/FAR, and it may be used to replace the current PDR/FAR used by the UPF-2, or alternatively, it may only replace/update a portion of the instant PDR/FAR. The SMF-2 may further send a VN session update response to the SMF-1. The VN session update response may optionally include the SMF-2 routing information. When SPF-1 receives the VN session update response, it may decide to update the PDR/FAR according to the SMF-2 routing information, if there is any change. The updated PDR/FAR may be provided to the UPF-1 to configure the UPF-1.

In certain circumstance, the SMF-1 may not be able to communicate with SMF-2, but the SMF-1 may communicate with an intermediate SMF (iSMF). The SMF-1 may send the VN session request to an Access and Mobility Management Function (AMF), and the AMF may in response assign an iSMF for SMF-1. The SMF-1 may thereby send the VN session request to the iSMF, including an VN ID, UPF-1 data communication tunnel information (which is a tunnel information allocated by an UPF-1 configured by or associated with SMF-1), and SMF-1 routing information. The iSMF may send the VN session request to the SMF-2, including the VN ID, an iUPF data communication tunnel information (which likewise is the data communication tunnel information allocated by an iUPF configured by or associated with the iSMF), and the SMF-A routing information. After the SMF-2 receives the VN session request sent form the iSMF, the SMF-2 may send a VN session response to the iSMF (because SMF-1 is not accessible directly). The VN session response may include the VN ID, the UPF-2 data communication tunnel information (which may be the data communication tunnel information allocated by a UPF-2 configured by or associated with the SMF-2), and the SMF-2 routing information. The iSMF may respond to SMF-1 with the VN session response, including the VN ID, iUPF data communication tunnel information, and SMF-2 routing information.

The SMF-1 can use the SMF-2 routing information to prepare the PAR/FAR and provide to the UPF-1 for configuration. The SMF-2 can use the SMF-1 routing information to prepare the PDR/FAR and provide to the UPF-2. The iSMF can use both the SMF-1 routing information and the SMF-2 routing information to prepare PAR/FAR and send to iUPF to configure the iUPF. The UPF-1 channel information can be provided to the iUPF, and the iUPF can use this information to create a data communication tunnel between the UPF-1 and the iUPF. The iUPF information may also be provided to the UPF-1 for establishing the data communication tunnel. The UPF-2 channel information can be provided to the iUPF, and the iUPF can use this information to create a data communication tunnel between the UPF-2 and the iUPF. The iUPF information may also be provided to the UPF-2 for establishing the data communication tunnel.

The VN ID (or VN group ID) can be Data Network Name (DNN) and/or Single Network Slice Selection Assistance Information (S-NSSAI), an internal group ID, a shared VN Group Data ID, or a new VN group ID value. Also, the SMF routing information can be the same as the UPF routing information.

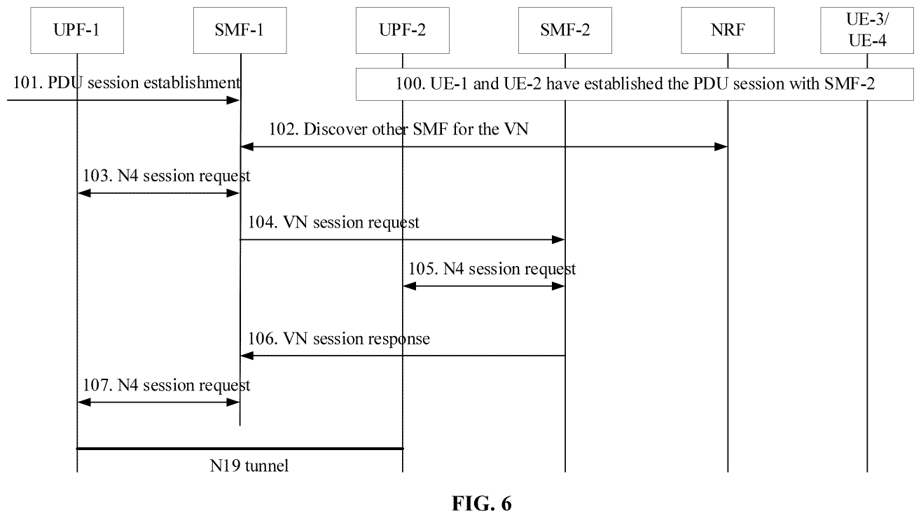

FIG. 6 shows another example signal flow among various core network components for a wireless virtual network according to an embodiment of this disclosure. The signal flow can be performed by the wireless communication systems of FIGS. 2A and 2B. Using the system in FIG. 2A as an example, the signal flow may include the following steps. These steps may not need to performed in described order unless specifically indicated.

100. Establishing the PDU sessions for the VN with SMF-2 having UE-3 and UE-4. The PDU sessions are anchored in the UPF-2. The IP addresses for these PDU sessions can be IP-3 and IP-4.

101. Receiving, by SMF-1, a PDU session establishment request from UE-1. The request may be transmitted from an AMF, an iSMF, or a vSMF. According to the information in the request, such as a DNN/S-NSSAI, the SMF-1 may know this PDU session is to be established for a certain VN group. The IP address for this PDU session can be IP-1.

102. Discovering, by the SMF-1, other SMF(s), such as SMF-2, for this VN. The identity of other SMFs for the same VN can be discovered by the steps 401 to 412 or other methods described in this disclosure. For example, the SMF-1 can obtain the information of other SMFs from a VN management network node, such as a NRF, UDM, or UDR.

103. Sending a N4 request, by the SMF-1, to the UPF-1 to request the UPF-1 to allocate the N19 tunnel resource corresponding to N19 data communication tunnel information of the UPF-1. The UPF-1 returns the UPF-1 data communication tunnel information to the SMF-1.

104. Sending, by the SMF-1, a VN session request to SMF-2. In the VN session request, the VN ID, the UPF-1 data communication tunnel information, and SMF-1 routing information are included. The SMF-1 routing information may include the IP address of the PDU session, i.e. IP-1, such that other network nodes can understand what network nodes are behind the SMF-1. In some cases, there may be multiple UPFs controlled under SMF-1, and correspondingly there may be multiple PDU sessions for the same VN. The SMF-1 may include multiple pieces of UPF data communication tunnel information. Each UPF data communication tunnel information corresponds to SMF routing information, e.g., different IP addresses for different UPFs.

105. Sending, by the SMF-2, a N4 request to UPF-2 to request UPF-2 to allocate a N19 tunnel resource corresponding to UPF-2 data communication tunnel information. Once the SMF-2 receives the VN session request, it may send the UPF-1 data communication tunnel information to the UPF-2. SMF-2 may also request the UPF-2 to allocate N19 tunnel resource and provide a corresponding UPF-2 data communication tunnel information. The UPF-2 may return the UPF-2 data communication tunnel information (e.g., a UPF-2 F-TEID). According to the UPF-1 data communication tunnel information and SMF-1 routing information, the SMF-2 configures the PDR/FAR of the UPF-2 for the VN. For example, when the UPF-2 detects a data packet from UE-1 for the VN, and the target address is IP-1, or a broadcast address for all the UEs under the VN, the UPF-2 may send the data packet to the UPF-1 via the N19 tunnel.

106. Sending, by the SMF-2, a VN session response to SMF-1. The VN session response may include the UPF-2 data communication tunnel information, SMF-2 routing information, and/or the VN ID. In this embodiment, the SMF-2 routing information may include IP-3 and IP-4 corresponding to the PDU session of UE-3 and UE-4. In another case if the UE-3 or UE-4 has joined one multicast group, the VN session response may further include a multicast address, e.g. MIP-A, which indicates the network node in the multicast group.

Likewise, if there are multiple UPFs configured by or associated with the SMF-2 and correspondingly there are multiple PDU sessions for VN, the VN session response may include multiple pieces of UPF data communication tunnel information. Each UPF data communication tunnel information corresponds to SMF routing information, which indicates the IP address of the corresponding PDU session.

107. Configuring, by SMF-1, PDF/FAR for the UPF-1 according to the UPF-2 data communication tunnel information and the SMF-2 routing information. After obtaining the UPF-2 data communication tunnel information and the SMF-2 routing information, the SMF-1 may configure the PDR/FAR in the UPF-1 for the VN. For example, according to the PDR/FAR, when the UPF-1 detects a data packet from UE-1 for the VN, and the target address is IP-3, IP-4, MIP-A (a multicast address), or a broadcast address, the UPF-1 may send the data packet to the UPF-2 via the N19 data communication tunnel.

Based on the PDR/FAR configured according to the data communication tunnel information and the SMF routing information, the UPFs under a multi-SMF scheme can properly direct a data packet it receives. The virtual network therefore can use multiple SMFs to manage the virtual network and revolve the prior geographic information.

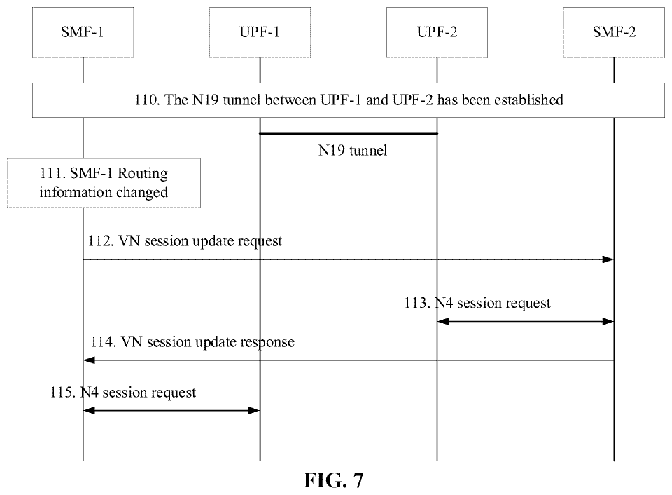

FIG. 7 shows another example signal flow among various core network components for a wireless virtual network according to an embodiment of this disclosure. The signal flow can be performed by the wireless communication systems of FIGS. 2A and 2B. Using the system in FIG. 2A as an example, the signal flow may include the following steps. These steps may not need to performed in described order unless specifically indicated.

110. Establishing a N19 data communication tunnel between a UPF-1 controlled by a SMF-1 and a UPF-2 configured by or associated with a SMF-2. During the establishment process, the SMF-1 and the SMF-2 may exchange data communication tunnel information and SMF routing information as explained by FIG. 6 and corresponding description above. Thus, the PDRs/FARs of the UPFs may have been configured.

111. Determining, by the SMF-1, the SMF-1 routing information has changed. The SMF-1 routing information may be changed for different reasons. For example, when a new PDU session for the same VN has been established under the SMF-1 and UPF-1, the SMF-1 routing information need to be updated to reflect the new PDU session and the network node connected to the PDU session. In this case, the IP address corresponding to the added PDU session can be add to the SMF-1 routing information. On the other hand, when a PDU session has been released, the IP address corresponding to the released PDU session may be removed for the SMF routing information. Additionally, if there is any UE, which has established a PDU session with SMF-1, again joins any multicast group, the IP address of the PDU session connected by the UE may be added to the multicast group address in the routing information.

112. Sending the VN session update request, by the SMF-1, to the SMF-2. The VN session update request may include the whole IP address set, that is, including those unchanged information pieces, or include only those changed information and indication/pointer to the changed information.

113. Configuring the PDR/FAR, by the SMF-2, for the UPF-2 for the VN according to the UPF-1 data communication tunnel information and the SMF-1 routing information. The UPF-1 data communication tunnel information and the SMF-1 routing information can be updated information. For example, if there is a newly-added IP address corresponding to a new PDU session under the SMF-1, the updated PDR/FAR enables the UPF-2 to send a data packet to the UPF-1 via the N19 data communication tunnel after the SMF-2 adds the updated IP address to the PDR/FAR as a target address. If a PDU sessions is released under the SMF-1, the SMF-2 may remove the IP address as a target address in the PDR/FAR.

114. Sending, by the SMF-2, a VN session update response to the SMF-1. In response to the VN session update request, the SMF-2 may send the VN session update response to the SMF-1. The VN session update response may include UPF-2 data communication tunnel information, SMF-2 routing information, and the VN ID. If there is no change to the UPF-2 data communication tunnel information and SMF-2 routing information, the VN session update response may omit the unchanged information.

115. Configuring PDR/FAR, by the SMF-1, for the UPF-1 according to the UPF-2 data communication tunnel information and the SMF-2 routing information. The UPF-2 data communication tunnel information and the SMF-2 routing information can be updated information. In this step, SMF-1 may prepare the updated PDR/FAR for the UPF-1 and may provide the updated PDR/FAR to the UPF-1, such that UPF-1 can forward a received data packet accordingly.

According to the steps above, if there is any change to the SMF routing information or the data communication tunnel information, the SMF may transmit the updated information to another SMF, such that the other SMF may use the updated information to configure updated PDR/FAR. Therefore, the data can be properly transmitted under a multiple SMFs topology.

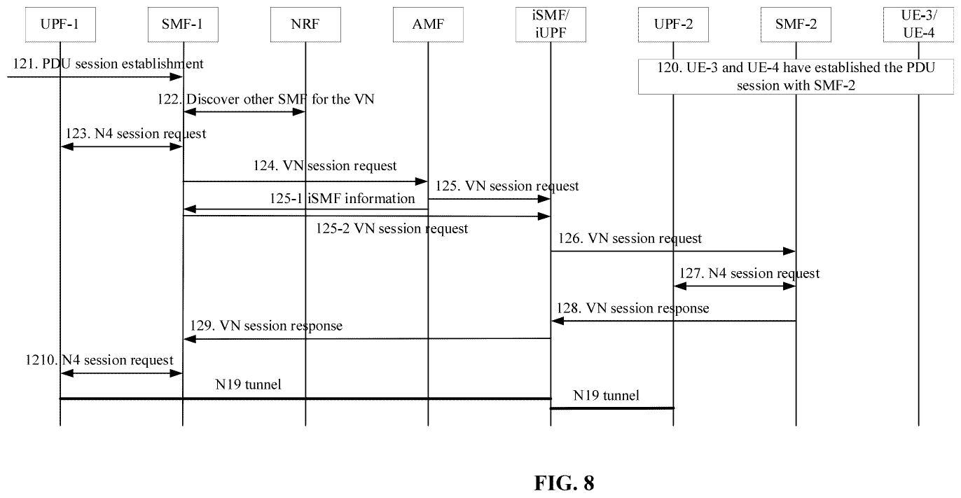

FIG. 8 shows another example signal flow among various core network components for a wireless virtual network according to another embodiment of this disclosure. The signal flow may be performed by the wires communication system as shown in FIGS. 2A, but there may be one intermediate SMF (iSMF) connected between the SMF-1 and the SMF-2. There may be an intermediate UPF (iUPF) connection between the UPF-1 and UPF-2. The method may comprise the following steps. These steps may not need to performed in described order unless specifically indicated.

120. Establishing the PDU sessions for the VN with a SMF-2 having a UE-3 and a UE-4. The PDU sessions are anchored in the UPF-2 as well. The IP addresses for these PDU sessions can be IP-3 and IP-4.

121. Receiving, by SMF-1, a PDU session establishment request from UE-1. The request may be transmitted from an AMF, an iSMF, or a vSMF. According to the information in the request, such as a DNN/S-NSSAI, the SMF-1 may know this PDU session is to be established for a certain VN group. The IP address for this PDU session can be IP-1.

122. Discovering, by the SMF-1, other SMF(s), such as SMF-2, for this VN. The other identity of other SMFs for the same VN can be discovered by the steps 401 to 412 or other methods disclosed in this disclosure. For example, the SMF-1 can obtain the information of other SMFs from a VN management network node, such as a NRF, UDM, or UDR.

123. Sending a N4 request, by the SMF-1, to the UPF-1 to request the UPF-1 to allocate the N19 tunnel resource corresponding to N19 data communication tunnel information of the UPF-1. The UPF-1 returns the UPF-1 data communication tunnel information to the SMF-1.

124. Determining, by the SMF-1, that the SMF-2 is not directly accessible and sending a VN session request to an AMF. The VN session request may include the VN ID, the UPF-1 data communication tunnel information, and SMF-1 routing information. The SMF-1 routing information may include the IP address of the PDU session under SMF-1, e.g. IP-1.

125. Selecting an iSMF by the AMF. The AMF may send the VN session request to a designated iSMF. The VN session request may also include address information of the SMF-2 (which can be provided by the SMF-1 to the AMF in the VN session request), such that the iSMF can locate the SMF-2 by the SMF-2 address information. Alternatively, the AMF may respond to the SMF-1 with the address information of the iSMF (step 125-1), and the SMF-1 may send the VN session request to the designated iSMF (step 125-2). In this case, the SMF-2 address information can also be included in the VN session request.

126. Requesting, by the iSMF, an iUPF to allocate two tunnel resources and sending the VN session request to the SMF-2 according to the SMF-2 address information. A tunnel resource iUPF tunnel I can be used to establish a N19 data communication tunnel between the iUPF and the UPF-1, and the tunnel resource iUPF tunnel 2 can be used to establish another N19 data communication tunnel between the iUPF and the UPF-2. Therefore, the iUPF can act as a relay to forward data packets between the UPF-1 and UPF-2. Additionally, if there are more than one UPF under the SMF-1 or SMF-2, the iSMF can request the iUPF to allocate multiple tunnel resources. Each tunnel resource may be used to establish an N19 tunnel between the iUPF and the UPF under the SMF-1 or SMF-2. Additionally, the iSMF may send the UPF-1 data communication tunnel information to the iUPF associated with the iSMF, so that the iUPF may gets the remote end (i.e. UPF-1) information of the tunnel between iUPF and UPF-1. This sending step can alternative be performed later.

According to the SMF-2 address information, the iSMF may send the VN session request to the SMF-2. The VN ID, an iUPF data communication tunnel 2 information, and the SMF-1 routing information may be included in the VN session request. The iUPF data communication tunnel 2 information may be used to established the N19 data communication tunnel between the iUPF and the UPF-2. The SMF-1 routing information may be used to configure the PDR/FAR of SMF-2.

127. Sending a N4 request, by the SMF-2, to the UPF-2 configured by or associated with the SMF-2 to allocate N19 tunnel resource and configure the PDR/FAR for the UPF-2 for the VN. The SMF-2 may send the iUPF data communication tunnel 2 information to the UPF-2, and ask the UPF-2 to allocate the tunnel resource for the N19 data communication tunnel between the iUPF and the UPF-2 correspondingly. The UPF-2 may return a UPF-2 data communication tunnel information (e.g. a UPF-2 F-TEID). Additionally, the SMF-2 may prepare the PDR/FAR for the UPF-2 according to the iUPF tunnel information and the SMF-1 routing information. According to the PDR/FAR of UPF-2, when the UPF-2 detects a data packet from UE-2 for the VN, and the target address is IP-1, IP-2, MIP-A (a multicast address), or a broadcast address, the UPF-2 may send the data packet to the iUPF via the N19 data communication tunnel for the iUPF to forward the data pack to the UE-1 and UE-2.

128. Sending, by the SMF-2, a VN session response to the iSMF. The VN session response may include the UPF-2 data communication tunnel information, the SMF-2 routing information, and the VN ID. In this case, the SMF-2 routing information may include IP-3 and IP-4 corresponding to the PDU sessions under the SMF-2. In another case if the UE-3 or UE-4 has joined one multicast group, the VN session response may further include a multicast address, e.g. MIP-A, which indicates the network node in the multicast group.

129. Sending, by the iSMF, UPF-2 data communication tunnel information to the iUPF and sending, by the iSMF, a VN session response to the SMF-1. The iSMF may send UPF-2 data communication tunnel information to the iUPF associated with the iSMF, such that the iUPF may get the remote end (i.e. UPF-2) information of the data communication tunnel between the iUPF and UPF-2. Further, the iSMF may also send the UPF-1 data communication tunnel information to the iUPF in this step 129 instead of in the previous step 126, so the iUPF get the remote end (i.e. UPF-1) information of the data communication tunnel between iUPF and UPF-1. The iUPF may establish the tunnel between iUPF and UPF-1 according to the UPF-1 data communication tunnel information. The iUPF may establish the tunnel between iUPF and UPF-2 according to the UPF-2 data communication tunnel information. Data communication tunnel information in this disclosure may include a Fully Qualified Tunnel Endpoint Identifier (F-TEID), including IP address and/or port and tunnel identifier (TEID) for receiving data packets.

Additionally, the iSMF may send the VN session response to the SMF-1. The VN ID, an iUPF data communication tunnel 1 information, and the SMF-2 routing information may be included in the VN session response. The iSMF may send the response to the SMF-1 directly or via the AMF.

1210. Configuring, by the SMF-1, the PDR/FAR for UPF-1 according the iUPF data communication tunnel 1 information and the SMF-2 routing information. For example, according to the PDR/FAR, when the UPF-1 detects a data packet from UE-1 for the VN, and the target address is IP-3, IP-4, MIP-A (a multicast address), or a broadcast address, the UPF-1 may send the data packet to the iUPF via the N19 data communication tunnel for the iUPF to forward the data pack to the UE-3 and UE-4.

The method above modified the method disclosed in the previous embodiment and make the method applicable to a VN with an intermediate SMF an intermediate UPF. It further expands the applicable circumstance of the methods disclosed in this disclosure.

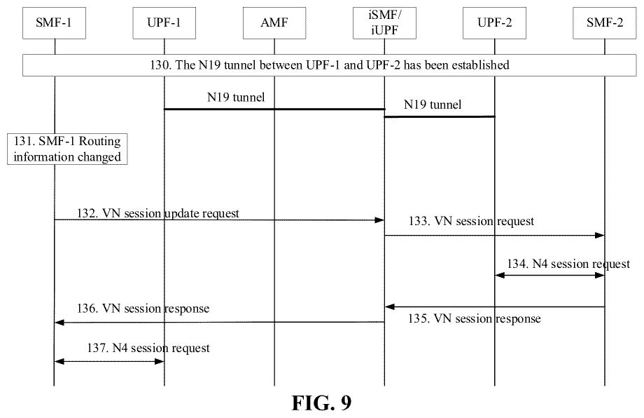

FIG. 9 shows another example signal flow among various core network components for a wireless virtual network according to another embodiment of this disclosure. The signal flow may be performed by the wires communication system as shown in FIGS. 2A, but there may be one intermediate SMF connected between the SMF-1 and the SMF-2. There may be an iUPF connection between the UPF-1 and UPF-2. The method may include the following steps. These steps may not need to performed in described order unless specifically indicated.

130. Establishing a N19 data communication tunnel between a UPF-1 configured by or associated with the a SMF-1 and a UPF-2 configured by or associated with a SMF-2. During the establishment process, the SMF-1 and the SMF-2 may exchange data communication tunnel information and SMF routing information as explained by FIG. 6 and corresponding description above. Thus, the PDRs/FARs of the UPFs may have been configured. Specifically, the N19 data communication tunnel here may include a first N19 data communication tunnel between UPF-1 and iUPF and a second N19 data communication tunnel between UPF-2 and iUPF.

131. Determining, by the SMF-1, the SMF-1 routing information has changed. The SMF-1 routing information may be changed for different reasons. For example, when a new PDU session for the same VN has been established under the SMF-1 and UPF-1, the SMF-1 routing information need to be updated to reflect the new PDU session and the network node connected to the PDU session. In this case, the IP address corresponding to the added PDU session can be add to the SMF-1 routing information. On the other hand, when a PDU session has been released, the IP address corresponding to the released PDU session may be removed for the SMF routing information. Additionally, if there is any UE, which has established a PDU session with SMF-1, again joins any multicast group, the IP address of the PDU session connected by the UE may be added to the multicast group address in the routing information.

132. Sending the VN session update request, by the SMF-1, to an iSMF. The VN session update request is sent to an iSMF in this case because the SMF-2 is not directly accessible by the SMF-1. The VN session update request may further include UPF-1 data communication tunnel information and SMF-1 routing information. The SMF-1 routing information may include the whole IP address set, that is, including those unchanged information pieces, or include only those changed information and indication of the changed information.

133. Sending, by the iSMF, the VN session update request to the SMF-2. The VN session update request may include the iUPF data communication tunnel 2 information, SMF-1 routing information, and/or the VN ID.

134. Configuring, by SMF-2, the PDR/FAR for the UPF-2 according to the iUPF data communication tunnel 2 information and SMF-1 routing information. For example, if there is a newly-added IP address corresponding to a new PDU session under the SMF-1, the updated PDR/FAR enables the UPF-2 to send a data packet to the UPF-1 via the N19 data communication tunnel after the SMF-2 adds the updated IP address to the PDR/FAR as a target address. If a PDU sessions is released under the SMF-1, the SMF-2 may remove the IP address from the target address in the PDR/FAR.

135. Sending, by the SMF-2, a VN session update response to the iSMF. The VN session update response may include the UPF-2 data communication tunnel information, SMF-2 routing information, and the VN ID. The UPF-2 data communication tunnel information can be used by the iSMF to establish a N19 data communication tunnel between the UPF-2 and iUPF according to the steps disclosed above.

136. Sending, by the iSMF, the VN session update response to the SMF-1. The VN session update response may include the iUPF data communication tunnel 1 information, the SMF-2 routing information, and the VN ID.

137. Configuring, by SMF-1, the PDR/FAR for UPF-1 according to the iUPF data communication tunnel 1 information and the SMF-2 routing information.

According to the steps above, if there is any change to the SMF routing information or the data communication tunnel information, the SMF may transmit the updated information to another SMF, such that the other SMF may use the updated information to configure updated PDR/FAR. Therefore, the data can be properly transmitted under a multiple SMFs topology. The embodiment here apply the process on a VN with iSMF, which extends the applicability of the invention. The various steps and methods disclosed above may be able to be combined and performed in any sequences, which combinations are covered by this disclosure.

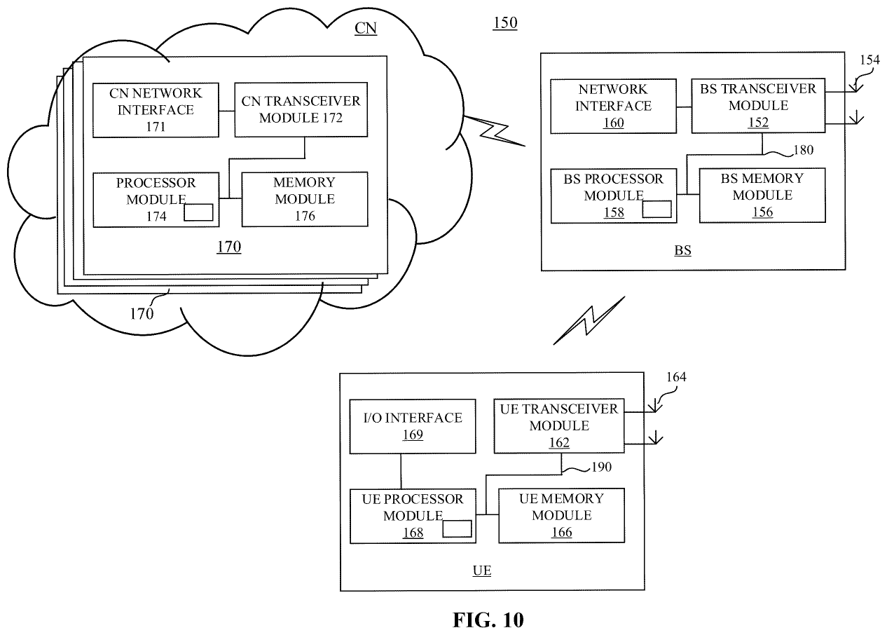

FIG. 10. shows the system hardware structure according to one embodiment of this disclosure. The system 150 may perform multiple steps disclosed in this disclosure.

The system 150 may include a base station (BS) and a user equipment (UE). The BS includes a BS transceiver or transceiver module 152, a BS antenna system 154, a BS memory or memory module 156, one or more BS processors or processor module 158, and a network interface 160. The components of the BS may be electrically coupled and in communication with one another as necessary via a data communication bus 180. Likewise, the UE includes a UE transceiver or transceiver module 162, a UE antenna system 164, a UE memory or memory module 166, one or more UE processors or processor module 168, and an I/O interface 169. The components of the UE may be electrically coupled and in communication with one another as necessary via a date communication bus 190. The UE and the BS may be in communication with each other.

The system 150 may further include a core network (CN). The core network, likewise, may include multiple computers 170, each includes a CN transceiver or transceiver module 172, a CN memory or memory module 176, one or more CN processors or processor module 174, and a network interface 171. The multiple computers collectively or separately may perform the different functions, such as AMF, SMF, and UPF, disclosed above. The multiple computers may communicate with each other to perform computing collectively or separately.

As would be understood by persons of ordinary skill in the art, the system 150 may further include any number of modules other than the modules shown in FIG. 10. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

The processors 158, 168, 174 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

According to one embodiment, this disclosure further provides a wireless communication apparatus, including one or more processors and a memory, storing one or more instructions, when being executed by the one or more processors, causing the wireless communication apparatus to perform any one of the methods and steps disclosed in this disclosure.

According to another embodiment, this disclosure further provides a non-transitory computer readable storage medium, storing one or more instructions, when being executed by one or more processors, causing a wireless communication apparatus to perform any one of the methods and steps disclosed in this disclosure.

Furthermore, the steps of a method or algorithm and the functions described in connection with the embodiments disclosed herein may be embodied directly in hardware, in firmware, in a software module executed by processors 158, 168, 174, respectively, or in any practical combination thereof. The memory modules 156, 166, 176 may be realized as RAM memory, flash memory, ROM memory, EPROM memory, EEPROM memory, registers, a hard disk, a removable disk, a CD-ROM, or any other form of storage medium known in the art. In this regard, the memory modules 156, 166, 176 may be coupled to the processors 158, 168, 174, respectively, such that the processors 158, 168, 174 can read information from, and write information to, memory modules 156, 166, 176, respectively. The memory modules 156, 166, 176 may also be integrated into their respective processor modules 158 and 168. In some embodiments, the memory modules 156, 166, 176 may each include a cache memory for storing temporary variables or other intermediate information during execution of instructions to be executed by processors 158, 168, 174, respectively. The memory modules 156, 166, 176 may also each include non-volatile memory for storing instructions to be executed by the processors 158, 168, 174, respectively.

The foregoing accompanying drawings are only schematic illustrations of the processing included in the method according to the exemplary embodiments of this disclosure, and are not intended for limitation. It is easily understood that the processes illustrated in the foregoing accompanying drawings do not indicate or define the chronological order of these processes. In addition, it is also easily understood that these processes may be performed, for example, synchronously or asynchronously in a plurality of modules.

What is claimed is:

1. A wireless communication method performed by a first Session Management Function (SMF) of a wireless core network, comprising:
receiving a first virtual network (VN) session request from a second SMF, the first VN session request comprising at least one of
a virtual network (VN) identifier (ID) of a VN,
first routing information, or
first data communication tunnel information for a first VN data communication session;
sending a first VN session response comprising at least one of
the VN ID,
second routing information of the first SMF, or
second data communication tunnel information for the first VN data communication session; and
configuring, according to the first routing information, a first packet detection rule (PDR) and a first forwarding action rule (FAR) for a first User Plane Function (UPF) associated with the first SMF to forward data packets of the first VN data communication session.

2. The method of claim 1, wherein the first routing information is routing information of the second SMF and the first data communication tunnel information is allocated by a second UPF associated with the second SMF.

3. The method of claim 1, wherein the first routing information is a routing information of a third SMF, the second SMF serves as an intermediate SMF (iSMF) between the first SMF and the third SMF, and the first data communication tunnel information is allocated by a second UPF associated with the second SMF.

4. The method of claim 3, wherein the first VN data communication session is between the first SMF and the second SMF serving as the iSMF.

5. The method of claim 1, wherein the first data communication tunnel information comprises a fully qualified tunnel endpoint identifier (F-TEID).

6. The method of claim 1, wherein the first routing information comprises at least one of address information of one or more PDU sessions of one or more user equipments (UEs) or a multicast address information corresponding to a multicast group communication.

7. The method of claim 1, further comprising sending a VN session update request to the second SMF, the VN session update request comprising the VN ID and updated routing information of the first SMF.

8. The method of claim 1, further comprising updating the PDR and FAR according to a VN session update request from the second SMF, the VN session update request comprising updated routing information.

9. The method of claim 8, wherein the updated routing information is updated routing information of the second SMF; or the updated routing information is updated routing information of a third SMF while the second SMF serves as an iSMF between the first SMF and the third SMF.

10. (canceled)

11. The method of claim 1, further comprising discovering another SMF under the same VN via a VN management network node.

12. The method of claim 1, wherein the first VN session request is from an Access and Mobility Management Function (AMF), which assigns the second SMF to be an iSMF, and is forwarded by the second SMF to the first SMF.

13. The method of claim 1, wherein the first VN session request is in response to a second VN session request sent from a third SMF, which requests an AMF to assign the second SMF as an iSMF and obtains information of the second SMF from the AMF.

14. A wireless communication method, comprising:
receiving, by an intermediate Session Management Function (iSMF) and from a first Session Management Function (SMF), at least one of a virtual network (VN) identifier (ID), a routing information of the first SMF, or data communication tunnel information of a first User Plane Function (UPF); and
transmitting, by the iSMF, to a second SMF, at least one of the VN ID, data communication tunnel information of an iUPF, and the routing information of the first SMF.

15. The method of claim 14, further comprising configuring, by the iSMF, a first packet detection rule (PDR) and a forwarding action rule (FAR) according to the routing information of the first SMF.

16. The method of claim 14, further comprising:
receiving, by the iSMF, at least one of the VN ID, VN data communication tunnel information of a second UPF, or routing information of the second SMF; and
transmitting at least one of the VN ID, the data communication tunnel information of the iUPF, or the routing information of the second SMF to the first SMF.

17. The method of claim 14, wherein the VN ID comprises at least one of DNN/S-NSSAI, an internal group IP, a shared VN Group Data ID, or a new VN Group ID value, and the data communication tunnel information of the first UPF comprises a fully qualified tunnel endpoint identifier (F-TEID).

18. (canceled)

19. The method of claim 14, further comprising:
receiving by the iSMF a request to establish a first data communication tunnel between the first UPF and the iUPF; and
sending a request to the second SMF to establish a second data communication tunnel between a second UPF and the iUPF.

20. The method of claim 14, wherein the iSMF is designated by an AMF in response to a request of the first SMF.

21. A wireless communication apparatus, comprising:
one or more processors; and
a memory, storing one or more instructions, when being executed by the one or more processors, causing the wireless communication apparatus to perform the following:
receiving a first virtual network (VN) session request from a second SMF, the first VN session request comprising at least one of
a virtual network (VN) identifier (ID) of a VN,
first routing information, or
first data communication tunnel information for a first VN data communication session;
sending a first VN session response comprising at least one of
the VN ID,
second routing information of the first SMF, or
second data communication tunnel information for the first VN data communication session; and
configuring, according to the first routing information, a first packet detection rule (PDR) and a first forwarding action rule (FAR) for a first User Plane Function (UPF) associated with the first SMF to forward data packets of the first VN data communication session.

22. A non-transitory computer readable storage medium, storing one or more instructions, when being executed by one or more processors, causing a wireless communication apparatus to perform the method of claim 1.
